(19) United States
(12) Patent Application Publication
(10) Pub. No.: US 2018/0203729 A1
(43) Pub. Date: Jul. 19, 2018

(54) PARALLEL STEP DETECTION FOR COMPLETING TASK

(71) Applicant: Lenovo (Singapore) Pte. Ltd., Singapore (SG)

(72) Inventors: Robert James Kapinos, Durham, NC (US); Scott Wentao Li, Cary, NC (US); Russell Speight VanBlon, Raleigh, NC (US); Timothy Winthrop Kingsbury, Cary, NC (US)

(21) Appl. No.: 15/407,007

(22) Filed: Jan. 16, 2017

(51) Int. Cl. G06F 9/48

(52) U.S. Cl. CPC G06F 9/4887; H04W 84/12

(57) ABSTRACT

One embodiment provides a method, including: receiving, at an information handling device, a task comprising a plurality of steps; providing, to at least one user, output associated with one of the plurality of steps in the task, wherein the one of the plurality of steps comprises a waiting duration; determining whether another of the plurality of steps can be performed during the waiting duration; and responsive to determining that another of the plurality of steps can be performed, providing output associated with the another of the plurality of steps. Other aspects are described and claimed.

### BACKGROUND

Information handling devices (“devices”), for example, smart phones, tablet devices, laptop computers, smart speakers, and the like, may employ voice-activated digital assistants (“digital assistants”) that are capable of receiving data and generating output associated with that data. One type of data that may be received corresponds to instructional data associated with a task (e.g., a cooking task, an assembly task, etc.). Advances in technology have enabled digital assistants to leverage this instructional data to provide (e.g., using vocal output, textual output, etc.) users with step-by-step instructions on how to complete a task.

### BRIEF SUMMARY

In summary, one aspect provides a method, comprising: receiving, at an information handling device, a task comprising a plurality of steps; providing, to at least one user, output associated with one of the plurality of steps in the task, wherein the one of the plurality of steps comprises a waiting duration; determining whether another of the plurality of steps can be performed during the waiting duration; and responsive to determining that another of the plurality of steps can be performed, providing output associated with the another of the plurality of steps.

Another aspect provides an information handling device, comprising: a processor; a memory device that stores instructions executable by the processor to: receive, at the information handling device, a task comprising a plurality of steps; provide, to at least one user, output associated with one of the plurality of steps in the task, wherein the one of the plurality of steps comprises a waiting duration; determine whether another of the plurality of steps can be performed during the waiting duration; and responsive to determining that another of the plurality of steps can be performed, providing output associated with the another of the plurality of steps.

A further aspect provides a product, comprising: a storage device that stores code, the code being executable by a processor and comprising: code that receives a task comprising a plurality of steps; code that provides, to at least one user, output associated with one of the plurality of steps in the task, wherein the one of the plurality of steps comprises a waiting duration; code that determines whether another of the plurality of steps can be performed during the waiting duration; and responsive to determining that another of the plurality of steps can be performed, code that provides output associated with the another of the plurality of steps.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of determining that a step can be performed during a waiting duration of another step.

FIG. 4(A-B) illustrates another example method of determining that a step can be performed during a waiting duration of another step.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Users often engage in activities that comprise a multitude of steps such as cooking, article assembly (e.g., furniture assembly, technology assembly, etc.), biological or chemical procedures (e.g., for procedures conducted in a laboratory environment), and the like. Digital assistant software employed on devices (e.g., Siri® for Apple®, Cortana® for Windows®, Alexa® for Amazon®, etc.) may generate output (e.g., textual output, audible output, etc.) that may guide a user through the steps in the task. For example, for a baking task, relevant output may include “crack the eggs,” “stir the contents in the bowl,” “place the pan in the oven,” etc.

Conventionally, digital assistants may output the steps in the task in a linear fashion. For example, a digital assistant may first vocally output one step to the user. Responsive to receiving completion input for the step from the user (e.g., vocal input, touch input, etc.), a digital assistant may provide output associated with a subsequent step. Some steps in the task may be associated with a waiting duration, which corresponds to a length of time (e.g., seconds, minutes, hours, etc.) that a user must wait for a step to be completed. For example, using the baking task mentioned above, output associated with a waiting duration step may be “bake the cake in the oven for 45 minutes.” Conventional digital assistants may set a timer for this waiting duration and generate output associated with another step when the waiting duration step is complete, or nearly complete. For example, after a cake has been baking in the oven for 45 minutes, a digital assistant may provide output associated with another step, e.g., prepare frosting to place on the cake.

However, these conventional methods are unable to determine whether another step can be performed during the duration of the waiting period. While conventional digital assistants are able to set manual timers, these timers are not tied to the underlying content. Additionally, conventional methods are not able to identify a user's efficiency in performing a particular step and are unable to determine whether the user can complete a step during the waiting duration. These deficiencies lead to longer task completion times because users often spend the waiting duration performing other activities (e.g., watching television, reading a book, etc.) rather than performing steps in the task that could simultaneously be accomplished during the waiting duration.

Accordingly, an embodiment provides a method of determining whether another step can be performed during the waiting duration of a previous step. In an embodiment, a task comprising a plurality of steps may be received at an information handling device (e.g., smart phone, tablet, smart speaker, laptop computer, etc.). Subsequent to receiving the task, an embodiment may provide output (e.g., vocal output, textual output, etc.) associated with one of the steps comprising a waiting duration. Upon identifying the step having a waiting duration, the system may determine whether one or more other steps could be performed during the waiting duration of the prior step. Responsive to determining that another step can be performed, an embodiment may generate output associated with that step. Such a method may increase the efficiency by which users can complete tasks and may also decrease the amount of time it takes users to finish the task.

The illustrated example embodiments will be best understood by reference to the figures. The following description is intended only by way of example, and simply illustrates certain example embodiments.

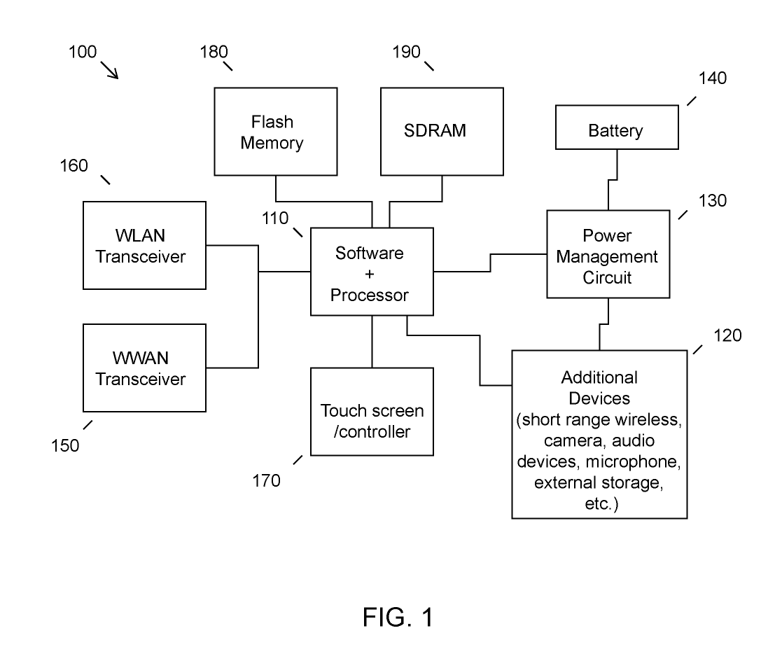

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera. System 100 often includes a touch screen 170 for data input and display/rendering. System 100 also typically includes various memory devices, for example flash memory 180 and SDRAM 190.

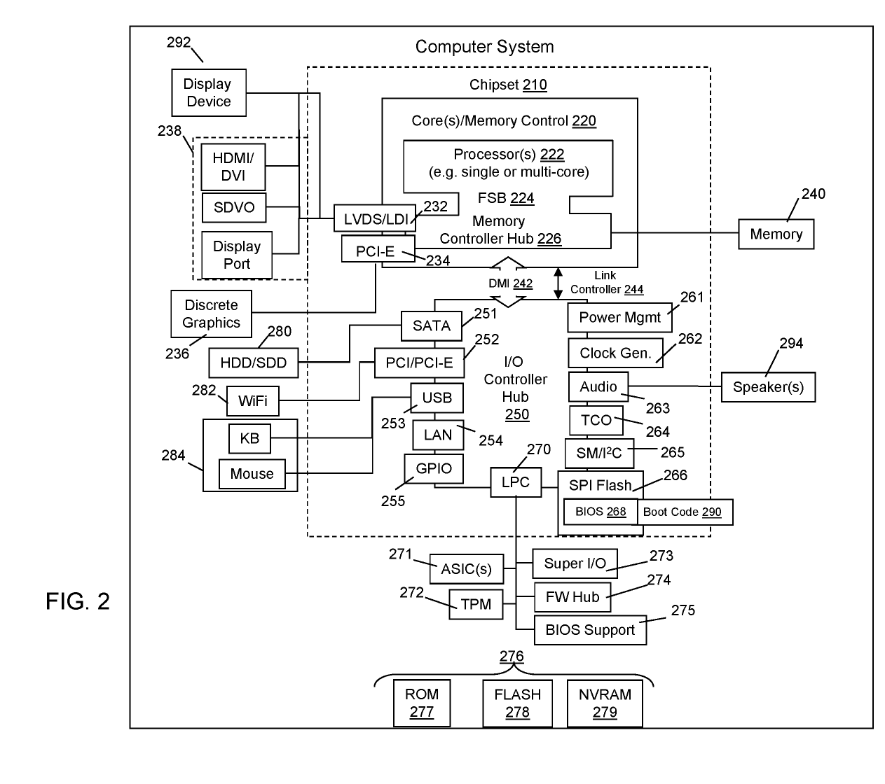

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices which users may use to provide output related to task instructions. Additionally, the devices may be used to determine whether a step in a task may be completed during the waiting duration of a prior step. For example, the circuitry outlined in FIG. 1 may be implemented in a tablet or smart phone embodiment, whereas the circuitry outlined in FIG. 2 may be implemented in a personal computer embodiment.

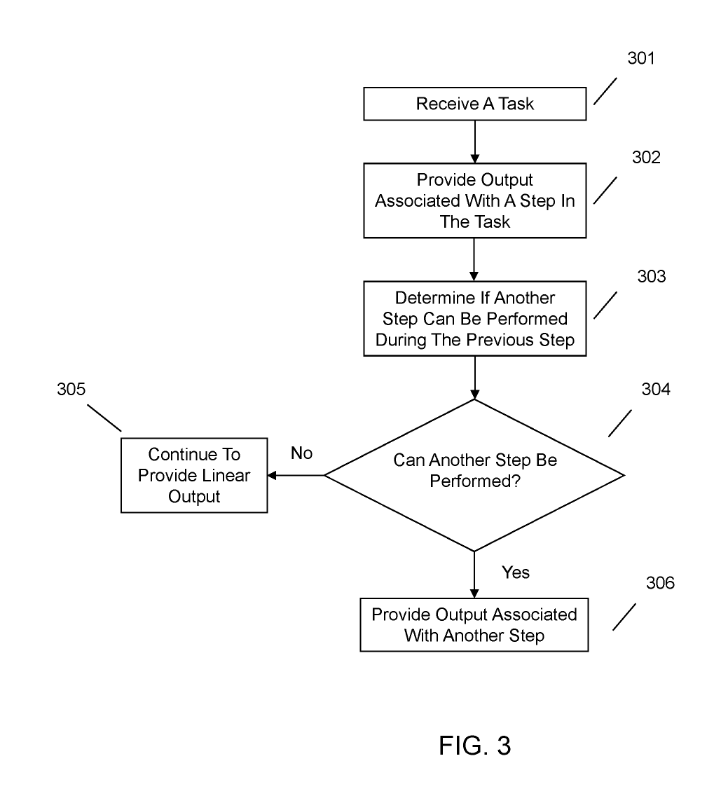

Referring now to FIG. 3, an embodiment may determine whether another step in a task may be performed during the waiting duration of a previous step and provide output associated with the other step. At 301, an embodiment may receive a task comprising a plurality of steps. In an embodiment, the task can be any task that takes multiple steps to complete. For example, the task may be associated with cooking, furniture assembly, laboratory experiments, etc. In an embodiment, each step in the task may comprise a user portion, a waiting duration, or a combination thereof. A step associated with a user portion may comprise one or more actions that a user needs to complete or perform. For example, for a cooking-based task, a user portion step may be associated with chopping vegetables, stirring sauce in a pan, placing meat in the oven, etc. A step associated with a waiting duration may correspond to a length of time (e.g., seconds, minutes, hours, etc.) where no user actions, or substantially no user actions, need to be taken. For example, using the cooking-based task above, a waiting duration step may be associated with leaving frozen meat out to thaw for 1 hour, baking a cake in the oven for 30 minutes, microwaving popcorn for 3 minutes, etc.

In an embodiment, the task may be provided to the device. For example, a user wishing to assemble a piece of furniture may provide the device with instructions associated with the assembly. The instructions may be provided, for example, by installing the instructions on the device, on another device accessible by the device, or at another location accessible by the device. Alternatively, in another embodiment, instructions associated with a task may be accessed by the device in response to a command. For example, a user may provide the command “find me a meatball sauce recipe.” Responsive to identifying the command, an embodiment may access (e.g., from an accessible database, from a website, etc.) a recipe associated with meatball sauces.

At 302, an embodiment may provide output associated with one of the steps in the task. In an embodiment, the output may be vocal output, textual output, or a combination thereof. For example, an embodiment may vocally output (e.g., using a speaker, another output device, etc.) to a user a step of “dice all of the vegetables.” Alternatively, or in combination with, an embodiment may output (e.g., on a display screen associated with the device, etc.) a textual version of the above mentioned step.

At 303, an embodiment may determine whether another step can be performed during a previous step. In other words, an embodiment may determine if one or more other steps can be completed in parallel with a step that has not yet been completed. For example, if a user has completed the user portion of a step and is now waiting for the waiting duration to be completed, an embodiment may determine if one or more other steps could be completed, performed, or started during the waiting duration of the previous step. An embodiment may identify if the step includes a waiting duration. If the step includes or comprises a waiting duration, an embodiment may determine whether another step may be performed during the time length of the waiting duration. To determine if the step includes a waiting duration, an embodiment may use a variety of methods. For example, an embodiment may parse the text included with the step and identify any time or durations associated with the step. The system may then associate the time or duration of the step as the waiting duration.

As another example, metadata may be attached to the task that contains duration information for various portions of the task. A task may contain metadata that corresponds to the length of time it takes to complete the entire task, individual steps of the task, or a combination thereof. In an embodiment, the metadata may be attached to each task by the user or, alternatively, an embodiment may load a task (e.g., from a website, from a database, from another storage location, etc.) that already has metadata attached to it. An embodiment may utilize this metadata in determining if another step can be performed during the waiting duration of a previous step. For example, an embodiment may identify (e.g., by accessing associated metadata) that a vegetable cutting step takes approximately 10 minutes to complete and can therefore determine that the vegetable cutting step can be completed during a 20 minute meat grilling step.

In an embodiment, the duration of the task may be adjusted based upon the rate of completion of steps within the task. In an embodiment, an initial duration for a task may be determined, for example, by accessing metadata associated with that task, receiving the input from a user, parsing the text, and the like. For example, metadata associated with a cake baking task may indicate that it will take 3 hours to complete the cake. An embodiment may adjust (e.g., reduce, increase, etc.) the duration of the task based upon how quickly a user is able to complete the steps in the task. For example, if the waiting duration associated with a task indicates that an egg-cracking step will take 10 minutes to complete, but an embodiment identifies (e.g., by receiving user-provided completion input, etc.) that a user completes the task in 5 minutes, an embodiment may decrease the overall completion time accordingly (e.g., from 3 hours to 2 hours and 55 minutes).

In one embodiment, the duration of subsequent performances of a step may be adjusted based upon the rate of completion of a step. The system may identify that a particular user performs a particular type of step at a certain rate. For example, an embodiment may identify a rate of completion associated with a step for inserting and tightening screws. The duration of another step in the task which includes inserting and tightening screws may then be adjusted based on the rate of completion of the previous step including inserting and tightening screws. Steps in a completely different task having similar steps may also be updated based on the rate of completion. The steps do not have to be identical in order to update the time associated with the task. For example, if one step requires inserting and tightening four screws and another step requires inserting and tightening eight screws, the system may update the estimated duration of the step having eight screws to be twice the duration of the step having four screws.

In an embodiment, a user's rate of completion for a particular step may be dynamically determined. The rate of completion may correspond to how long it takes a user to accomplish a particular step. For example, for a step associated with cutting a set of vegetables, an embodiment may determine how long it takes the user to cut those vegetables. In an embodiment, the rate may be determined, for example, by beginning a timer when a user starts the step and stopping the timer when an indication (e.g. user-provided completion input, etc.) is received that the step is completed. Alternative methods for determining the completion rate of a step may be utilized but are not described here.

An embodiment may refer to a user's rate of completion to determine whether a step can be performed during the waiting duration of a previous step. For example, if a user's rate of completion to cut a set of vegetables is 10 minutes, an embodiment may determine that a vegetable cutting step may be completed during a 20 minute meat grilling step. In an embodiment, the rate of completion can be stored locally (e.g., on the device), remotely (e.g., the cloud, network storage location, etc.), or a combination thereof. The rate of completion can subsequently be accessed when a similar step in a different task is being performed. For example, if a user's vegetable cutting rate is determined to be 10 minutes in recipe A, an embodiment may utilize that rate when making determinations in recipe B.

In an embodiment, multiple users may access and use a single device. In such a situation, an embodiment may identify a user prior to accessing completion rates associated with that particular user. For example, multiple users may have the ability to access a device, or a digital assistant stored on a device, by logging into a user profile. Each user profile may contain a variety of settings, including rates of completion for particular steps, which may be specific to the identified user. For example, User A may gain access to a user profile on a device by providing user identification data (e.g., a digital fingerprint, user-associated passcode, user credentials, etc.) to an input field or an input location associated with the device. Subsequent to granting User A access to their user profile, an embodiment may have access to various completion rates associated with User A. If User B logs in to a user profile associated with User B on the same device, an embodiment may access completion rates specific to User B rather than the completion rates associated with User A.

At 306, responsive to determining that another step can be performed (i.e., a parallel step, a branch step, etc.), an embodiment may provide output associated with the other step. In an embodiment, the output may correspond to instructions associated with the other step. At 305, responsive to determining that another step cannot be performed, an embodiment may provide, at 304, output in a linear or serial fashion. For example, output associated with a step may be provided only after an indication is received that a prior step is complete. The indication may correspond to user provided input (e.g., voice input, touch input, etc.) that the step is complete. Alternatively, the indication may correspond to a determination that the countdown timer associated with a waiting duration step has run down to zero.

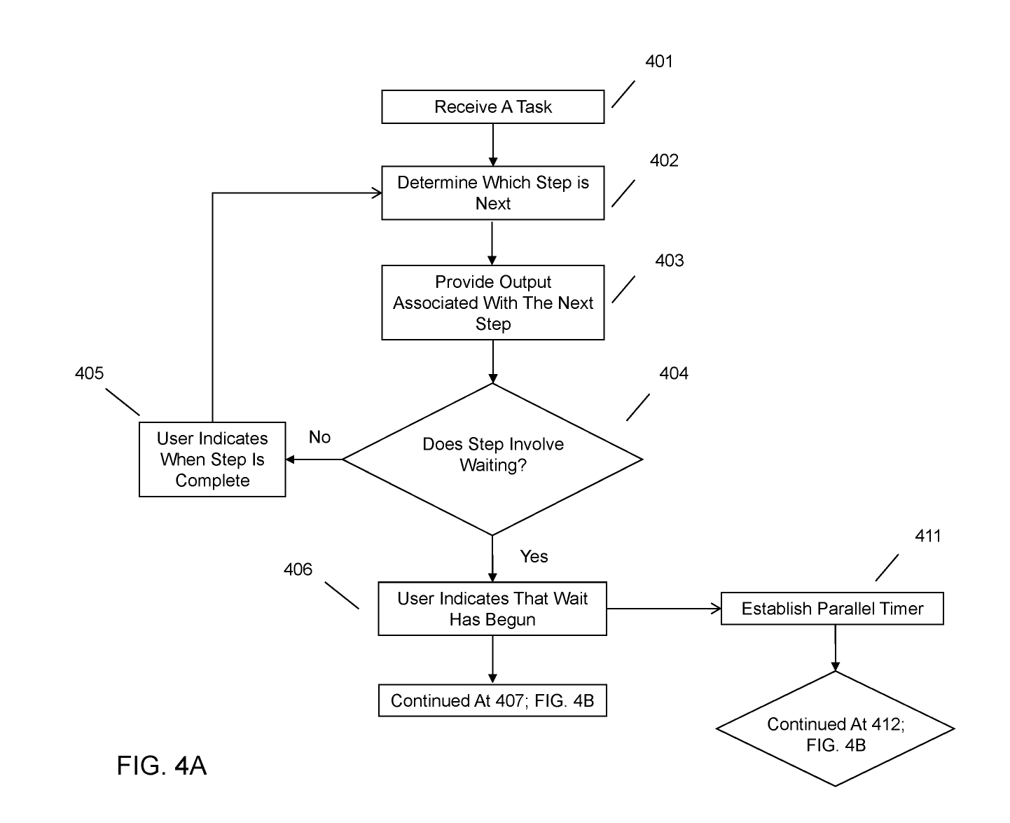

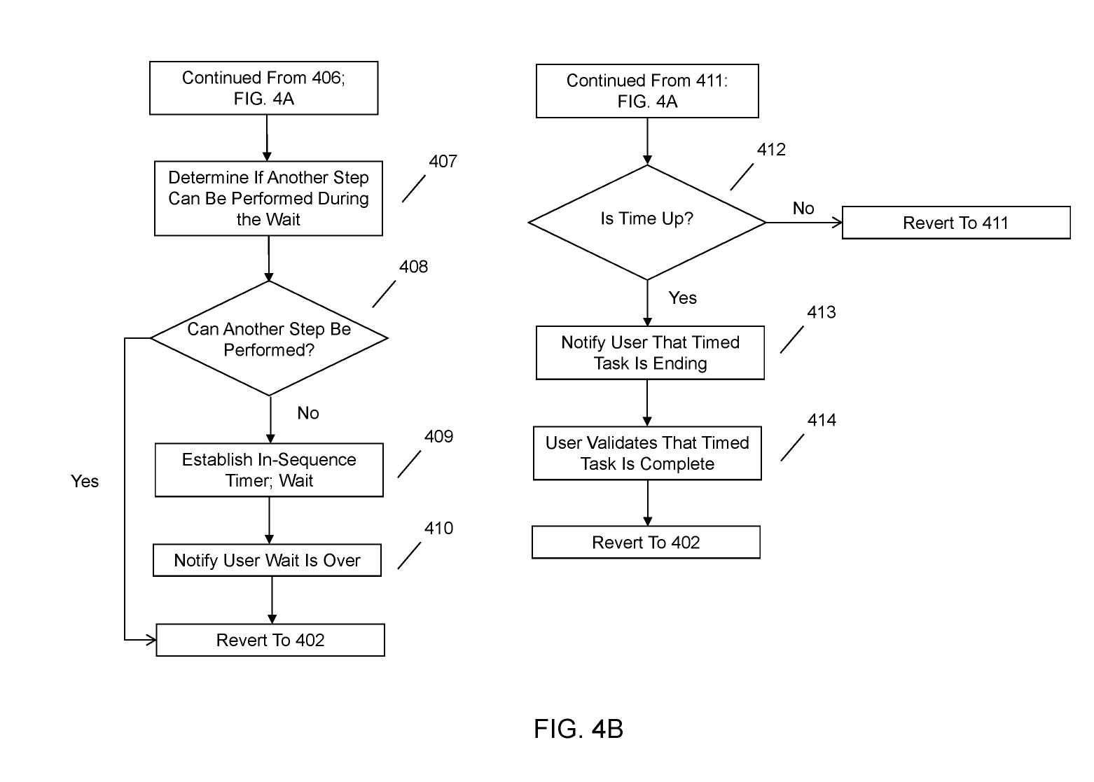

Referring now to FIG. 4(A-B), a more detailed illustration of determining that a step can be performed during a waiting duration of another step is presented. At 401, an embodiment may receive a task (e.g., cooking task, assembly task, etc.) and determine, at 402, which step in the task is next in line, for example, which step is sequentially the next step, the next dependent step, parallel steps, and the like. In an embodiment, the determination may be made from the set of time dependent tasks, linear progression tasks, parallel activities, and the like. At 403, an embodiment may provide output (e.g., vocal output, textual output, etc.) to a user associated with the next step and identify, at 404, whether or not the step involves a waiting duration.

If the system identifies that the step does not include a waiting duration oat 404, an embodiment may wait until an indication (e.g., vocal input, touch input, keyboard input, etc.) is received from a user indicating the step is complete. Subsequent to receiving the indication, at 405, an embodiment may revert back to 402 to determine which step is next in the task. However, if the system identifies that the step does include a waiting duration at 404, an embodiment may wait to receive an indication from a user that the waiting duration has begun, at 406.

Once the waiting duration has begun, an embodiment may establish, at 411, a parallel timer, for the step having the waiting duration, and determine, at 407, if another step can be performed during the waiting duration. In the event that another step can be performed, at 408, an embodiment may revert back to 402 to determine which step can be performed provide output, at 403, associated with that step. If, at 408, the system determines that another step cannot be performed, an embodiment may establish, at 409, an in-sequence timer and wait for the step to be completed. Once the in-sequence timer indicates that the wait is over, an embodiment may notify, at 410, a user that the waiting duration is complete and revert to 402 to determine which step, if any, is next in the task.

While completing steps 407-410 the parallel timer established at 411 is running. Thus, the system, in parallel with steps 407-410 is completing steps 412-414. At 412, an embodiment may identify whether the parallel timer has ran out of time. If the time on the parallel timer has not run out at 412, an embodiment may revert to 411. However, if the parallel timer has run at 412, an embodiment may notify, at 413, a user that the timed task is ending. A user may validate that the timed task is complete by providing an indication to the device at 414. An embodiment may then revert to 402 to determine which step, if any, is next in the task.

The various embodiments described herein thus represent a technical improvement to providing instructional output associated with steps in a task. Using the techniques described herein, an embodiment may determine whether a user may be able to complete a step in a task during a waiting duration of a previous step. Such techniques increase task completion efficiency and may also decrease the amount of time it may take a user to complete the task.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, at an information handling device, a task comprising a plurality of steps;
providing, to at least one user, output associated with one of the plurality of steps in the task, wherein the one of the plurality of steps comprises a waiting duration;
determining whether another of the plurality of steps can be performed during the waiting duration; and
responsive to determining that another of the plurality of steps can be performed, providing output associated with the another of the plurality of steps.

2. The method of claim 1, further comprising identifying the at least one user has performed a step preceding the one of the plurality of steps.

3. The method of claim 2, wherein the identifying comprises receiving an indication that the at least one user has performed the preceding step.

4. The method of claim 3, wherein the indication comprises an input action provided by the user.

5. The method of claim 1, further comprising initiating a countdown timer comprising the waiting duration.

6. The method of claim 1, further comprising, responsive to determining that another of the plurality of steps cannot be performed, providing output associated with a step subsequent to the one of the plurality of steps upon completion of the waiting duration.

7. The method of claim 1, further comprising determining a rate of completion of a step by the user.

8. The method of claim 7, further comprising storing, at an accessible storage location, the rate of completion associated with the step completed by the user.

9. The method of claim 1, wherein the task comprises metadata identifying a duration of the task.

10. The method of claim 8, further comprising adjusting the duration of the step for subsequent performances of the step based upon the stored rate of completion associated with the step.

11. An information handling device, comprising:
a processor;
a memory device that stores instructions executable by the processor to:
receive, at the information handling device, a task comprising a plurality of steps;
provide, to at least one user, output associated with one of the plurality of steps in the task, wherein the one of the plurality of steps comprises a waiting duration;
determine whether another of the plurality of steps can be performed during the waiting duration; and
responsive to determining that another of the plurality of steps can be performed, providing output associated with the another of the plurality of steps.

12. The information handling device of claim 11, wherein the instructions are further executable by the processor to identify the at least one user has performed a step preceding the one of the plurality of steps.

13. The information handling device of claim 12, wherein the instructions executable by the processor to identify comprises instructions executable by the processor to receive an indication that the at least one user has performed the preceding step.

14. The information handling device of claim 11, wherein the instructions are further executable by the processor to initiate a countdown timer comprising the waiting duration.

15. The information handling device of claim 11, wherein the instructions are further executable by the processor to provide, responsive to determining that another of the plurality of steps cannot be performed, output associated with a step subsequent to the one of the plurality of steps upon completion of the waiting duration.

16. The information handling device of claim 11, wherein the instructions are further executable by the processor to determine a rate of completion of a step by the user.

17. The information handling device of claim 16, wherein the instructions are further executable by the processor to store, at an accessible storage location, the rate of completion associated with the step completed by the user.

18. The information handling device of claim 11, wherein the task comprises metadata identifying a duration of the task.

19. The information handling device of claim 18, wherein the instructions are further executable by the processor to adjust the duration of the step for subsequent performances of the step based upon the stored rate of completion associated with the step.

20. A product, comprising:
a storage device that stores code, the code being executable by a processor and comprising:
code that receives a task comprising a plurality of steps;
code that provides, to at least one user, output associated with one of the plurality of steps in the task, wherein the one of the plurality of steps comprises a waiting duration;
code that determines whether another of the plurality of steps can be performed during the waiting duration; and
responsive to determining that another of the plurality of steps can be performed, code that provides output associated with the another of the plurality of steps.
